(19) United States
(12) Patent Application Publication
(10) Pub. No.: US 2018/0314821 A1
(43) Pub. Date: Nov. 1, 2018

(54) Transferring Containers

(71) Applicant: Microsoft Technology Licensing, LLC, Redmond, WA (US)

(72) Inventors: Kyle Thomas Brady, Seattle, WA (US); John C. Gordon, Newcastle, WA (US); Benjamin M. Schultz, Bellevue, WA (US); Ali Hajy, Seattle, WA (US); Morakinyo Korede Olugbade, Seattle, WA (US); Hari R. Pulapaka, Redmond, WA (US); Paul McAlpin Bozzay, Redmond, WA (US); Frederick Justus Smith, Redmond, WA (US); Mehmet Iyigun, Kirkland, WA (US)

(73) Assignee: Microsoft Technology Licensing, LLC, Redmond, WA (US)

(21) Appl. No.: 15/498,234

(22) Filed: Apr. 26, 2017

(51) Int. Cl. G06F 21/53; G06F 21/44

(52) U.S. Cl. CPC G06F 21/53; G06F 2221/034; G06F 21/44

(57) ABSTRACT

A container comprising an isolated computing session is associated with a project. One or more users associated with the container can access the container across multiple usage sessions as the container keeps data, applications, and so on for the project together. The container can comprise multiple layers that require user authentication to access.

### BACKGROUND

The use of computing devices continues to change the ways people communicate, collaborate, and share information. As the prevalence of computing devices continues to expand, users desire seamless access to their data across devices, and as groups of users desire to collaborate, access to and control of the shared data is required. The increasing connectivity is not without its problems. One such problem is that users want to be able to collaborate and share data without sacrificing the security of their data.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a container is associated with a project. The container comprises an isolated computing space and contains one or more programs or files. The container is opened at a host device responsive to one or more triggers indicating a usage session is starting. One or more changes made during the usage session to one or more application, layer, or data contained in the container are recorded, and the container and one or more changes are saved.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is a block diagram illustrating an example system for implementing transferring containers in accordance with one or more embodiments.

FIG. 2 is a data flow illustrating an example usage scenario for transferring containers.

FIG. 3 is a flowchart illustrating an example process for implementing transferring containers in accordance with one or more embodiments.

FIG. 4 is a flowchart illustrating another example process for implementing transferring containers in accordance with one or more embodiments.

FIG. 5 is a flowchart illustrating another example process for implementing transferring containers in accordance with one or more embodiments.

FIG. 6 is a flowchart illustrating another example process for implementing transferring containers in accordance with one or more embodiments.

FIG. 7 is a block diagram illustrating an example container for implementing transferring containers in accordance with one or more embodiments.

FIG. 8 illustrates an example system that includes an example computing device that is representative of one or more systems and/or devices that may implement the various techniques described herein.

### DETAILED DESCRIPTION

Transferring containers is discussed herein. The techniques discussed herein support using containers for isolating meetings and allowing a meeting to roam with users across multiple usage sessions. A container refers to a virtualization layer for a computing device and is used for isolation as well as hardware resource partitioning. A container can include one or more of various different components, such as a base operating system (e.g., an operating system kernel), a user-mode environment, an application or program, virtual devices (e.g., processors, memory), operating system services, combinations thereof, and so forth. A usage session refers to the time span beginning when one or more users begin to use the computing device, and ending when the one or more users cease using the computing device. A project refers to a set of usage sessions during which a set of users interacts with a same container over the course of multiple usage sessions.

A container can be associated with a particular project. The project can also be associated with email chains, chats, documents, files, meetings, and so on. The container is used to keep data from the project together so that the data can be revisited and easily accessed. A container can be saved and stored in a cloud for access from multiple computing devices over the course of a project. A container can include any range of data including user settings, application settings, files, locations for retrieving data, and so on. Optionally, a container can comprise one or more layers and each layer can contain different data for the container. A layer may be secured differently from the container as a whole, for instance requiring user authentication to access.

For a particular project, a container can be used to maintain data relating to the project. This data can include data initially residing in the container as well as changes made to the container during the course of a usage session. Thus, the container can be used multiple times during the course of the project to maintain data so that a meeting can be continued at another time and place. Layers can be used to enable multiple groups to use the same container for the project with different purposes.

For example, a design team and a marketing team might simultaneously be working on a same project, but the design team needs space that is not shared with the marketing team to ensure that the marketing team does not use information that is not ready to be shared with the public. The design team can have a layer in the container that can only be accessed by members of the design team. Similarly, the marketing team may have a layer that can only be accessed by members of the marketing team. Later, when the design team and marketing team are ready to present the project, the layers can be merged into a final presentation.

The techniques discussed herein provide both security and ease when accessing a project. Users can maintain information about a project in an isolated computing space that can be accessed from a variety of computing devices and saved to a cloud. In this way, data need not maintained by the computing device used to access the container, but instead can be maintained by the container itself. The users will know that data relevant to their meeting is maintained and can be accessed by them again without having to recreate the environment (e.g., the container components). In this way, users can readily use public computing devices to achieve the same functionality and security they enjoy on their personal computers.

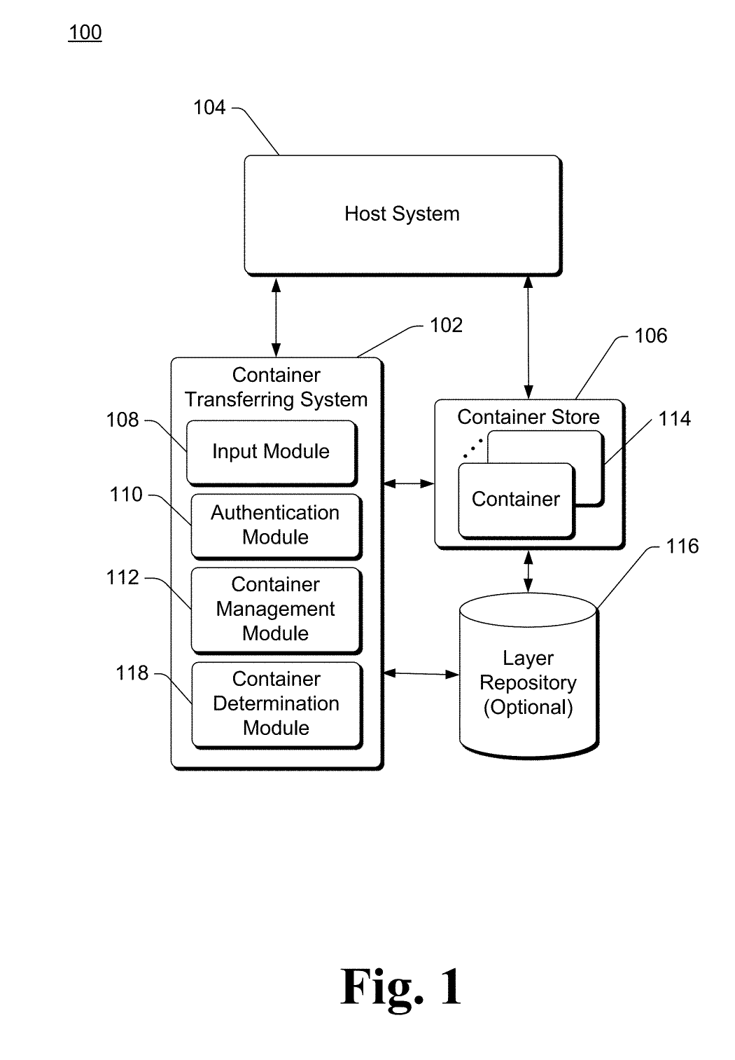

FIG. 1 illustrates an example system 100 implementing transferring containers in accordance with one or more embodiments. System 100 is implemented at least in part by one or more computing devices. Any of a variety of different types of computing devices can be used to implement the system 100, such as a server computer, a desktop computer, a laptop or netbook computer, a virtual meeting hosting device, a mobile device (e.g., a tablet or phablet device, a cellular or other wireless phone (e.g., a smartphone), a notepad computer, a mobile station), a wearable device (e.g., eyeglasses, head-mounted display, watch, bracelet, virtual reality (VR) glasses or headset, augmented reality (AR) headset or glasses), an entertainment device (e.g., an entertainment appliance, a set-top box communicatively coupled to a display device, a game console), Internet of Things (IoT) devices (e.g., objects or things with software, firmware, and/or hardware to allow communication with other devices), a television or other display device, an automotive computer, and so forth. Thus, the computing devices implementing system 100 may range from a full resource device with substantial memory and processor resources (e.g., personal computers, game consoles) to a low-resource device with limited memory and/or processing resources (e.g., traditional set-top boxes, hand-held game consoles).

The system 100 includes a container transferring system 102 and a host system 104. In one or more embodiments, the container transferring system 102 is implemented in a network environment further comprising multiple host system 104. Alternatively, at least part of the container transferring system 102 can be implemented on a same device implementing the host system 104. The container transferring system 102 tracks and associates containers, layers, and users in order to provide appropriate containers to a host system 104 as requested by a user. The host system 104 can be implemented on any computing device as described above and serves as a system on which the container is run.

Additionally, a container store 106 for storing the containers 114 while they are not in use at a host system 104 can be implemented on the same or a different device from that on which the container transferring system 102 or host system 104 are implemented. For instance, the container store 106 can be implemented as part of the container transferring system 102, as part of the host system 104, or as part of a cloud accessible by the container transferring system 102 and one or more host system 104. Alternately, the container store 106 could be implemented as a standalone device.

Each container 114 is an isolated computing space provisioned with various data for a meeting. Multiple containers can be run at the host system 104 concurrently, with each container including one or more components. These components include, for example, virtual devices (e.g., one or more processors, memory, storage devices), a base operating system (e.g., an operating system kernel), a user-mode environment, applications, and so forth. A base operating system component provides various different low level system services to components in the container, such as session management, program execution, input/output services, resource allocation, and so forth. The base operating system component can be a full operating system, or alternatively only a portion of a full operating system (e.g., the base operating system component may be a very small component if the container shares most of the operating system with the host (in particular, the kernel)). The user-mode environment component provides a runtime environment for applications in the container (e.g., a Java Runtime Environment, a .NET framework, and so forth). The application component is an application that is desired (e.g., by a user, administrator, other program, etc.) to be run in the container (e.g., a web service, a calculation engine, etc.).

One type of container that a container 114 can be implemented as is referred to as a process container. For a process container, the application processes within the container run as if they were operating on their own individual system (e.g., computing device), which is accomplished using namespace isolation. The host system 104 implements namespace isolation. Namespace isolation provides processes in a container a composed view consisting of the shared parts of the host operating system and the isolated parts of the operating system that are specific to each container such as file system, configuration, network, and so forth.

Another type of container that a container 114 can be implemented as is referred to as a virtualized container. For a virtualized container, the virtualized container is run in a lightweight virtual machine that, rather than having specific host physical memory assigned to the virtual machine, has virtual address backed memory pages. Thus, the memory pages assigned to the virtual machine can be swapped out to a page file. The use of a lightweight virtual machine provides additional security and isolation between processes running in a container. Thus, whereas process containers use process isolation or silo-based process isolation to achieve their containment, virtualized containers use virtual machine based protection to achieve a higher level of isolation beyond what a normal process boundary can provide. A container may also be run in a virtual machine using physical memory of the host system 104, and cloning can be used to copy the state of the template container into the physical memory used by the new container. Such a container using physical memory allows for higher isolation, e.g., in situations where the use of virtual memory for the virtual machine is not desired because of performance or security concerns.

The system 100 also optionally includes a layer repository 116. The layer repository can be implemented as part of the container store 106 or can be separate from the container store 106. The layer repository 116 can be encrypted to ensure that layers are kept secure. The use of layers can help implement container transferring by containing data at different permission levels in different layers. For instance, a base layer can be included for each meeting and be accessible to all users associated with the meeting. Additional layers can be included in the container based on permissions associated with a particular user. These layers can include team specific layers, user specific layers, host system specific layers, setting layers, application layers, and so on.

Layers associated with a meeting or project can be static or dynamic and the layers can be stored or created as needed. When a container 114 is requested at a host system 104, the host system 104 facilitates user authentication with an authentication module 110 of the container transferring system 102. The container transferring system 102 determines which layers of multiple layers associated with the container and meeting the authenticated user has permission to access. These layers are retrieved from the layer repository 116 and included in the container retrieved from the container store 106. The container 114 associated with the meeting can be empty prior to the associated layers being added, or can comprise one or more settings, files, programs, etc. The container including the layers is then provided to the host system 104.

The container transferring system 102 includes an input module 108. The input module 108 receives inputs from a variety of sources including user inputs provided by a user, and inputs received over a network from other devices. User inputs can be given at the computing device on which the container transferring system 102 is implemented, or on an external computing device. These inputs can be provided by a user pressing one or more keys of variety of different manners, such as by pressing one or more keys of a keypad or keyboard of the computing device, pressing one or more keys of a controller (e.g., remote control device, mouse, track pad, etc.) of the computing device, pressing a particular portion of a touchpad or touchscreen of the computing device, making a particular gesture on a touchpad or touchscreen of the computing device, and/or making a particular gesture on a controller (e.g., remote control device, mouse, trackpad, etc.) of the computing device. User inputs can also be provided via other physical feedback input to the computing device, such as tapping any portion of the computing device, an action that can be recognized by a motion detection or other component of the computing device (such as shaking the computing device, rotating the computing device, bending or flexing the computing device, etc.), and so forth. User inputs can also be provided in other manners, such as via voice or other audible inputs to a microphone, via motions of hands or other body parts observed by an image capture device, and so forth. User inputs can be provisioned to the input module 108 directly or indirectly.

Additionally, the input module 108 can receive inputs from additional devices over a network. One of the additional devices from which the input module 108 can receive input is the host system 104. The host system 104 can generate inputs for the container transferring system 102 itself, or receive inputs from a user. For instance, the host system 104 can maintain a schedule of meetings and request a container related to a scheduled meeting. Alternately or additionally, the host system 104 can receive user credentials and transmit them to the container transferring system 102. These credentials can take any desired form including username and password, biometric, near-field communication (NFC), or ID card.

The authentication module 110 can receive user credentials from the input module 108 which can either directly receive the user credentials from a user or receive them from the host system 104. Based on the user credentials, the authentication module 110 can determine a degree of access a user or group of users can have to a container. The authentication module 110 can make such determinations in various manners, such as based on rules or polices included in the authentication module 110, based on rules or polices associated with the host system 104, based on input from a user of the system 100, based on data stored in the container being accessed, based on an access control list associated with a file or layer, and so forth. For instance, the authentication module 110 can determine that a single user has access only to particular layers of a container. Additionally, the authentication module 110 can determine that a group of users, or subset of a group of users is required to access a layer or container.

For instance, if a container belongs to a group of five users, the container can be entirely accessible to any of the five users. Alternately, the container may require some threshold of users be present (such as 2 users or 40% of users) in order to access the container. Further, the authentication module 110 can authenticate a user to a part of a container and deny access to another part of the container. For instance, if each of the five users has a personal layer saved within the container, the user can have access to the base layer of the container and their own personal layer but deny access to the personal layers associated with the other users.

The authentication module 110 can further determine a change in the present users. Responsive to the change, the authentication module 110 can re-determine the access to the container that the user or group of users is granted. For instance, if a new user arrives a layer associated with the new user can be added to the container. Alternately, if the new user has fewer permissions than the initial group of users, the access to the container can be reduced. Conversely, if a user with the fewest permissions in a group leaves, greater access to the container can be granted. The authentication module 110 can provide these changes to the host system 104, so the users are presented with a refreshed view that reflects the updated access level. Other methods to dynamically change the access to a container during a usage session such as dynamically recalculating pointers, reparse points, and/or hard links are considered.

The container transferring system 102 further includes a container management module 112. The container management module 112 tracks associations of users with projects, containers, and layers. The container management module 112 can determine based on the user authentication what a particular user has permission to access (e.g., which documents, files, projects, containers, and/or layers) and can retrieve the container and appropriate layers and provision them to the host system 104. The container management module 112 can also create containers and layers as needed.

Additionally, the container management module 112 can manage associations beyond what occurs in the containers, such as associating a project with one or more emails, instant messaging (IM) chats, and so on. In this way, a user can request an overview of data in order to view how the project developed over time.

The container management module 112 can track these associations in various manners. For example, a record of the associations for a container 114 may be included in the container (e.g., encrypted for or otherwise accessible only to the container management module 112), in a record maintained by or otherwise accessible to the container management module 112, and so forth.

The container transferring system 102 further includes a container determination module 118. Alternately, the container determination module 118 can be implemented at least in part in the container store 106. The container determination module 118 determines contextual data to pass to the container store 106 to determine which container 114 or project a user or group of users is trying to access. For instance, the container determination module 118 may simply receive an identifier of the container or project (e.g., a name of the container or project) and pass the identifier to the container store 106 to request the container 114. The identifier can be associated with a scheduled meeting, with a user, can be entered manually by the user at the host system 104, or received in any other desired manner.

Alternately, the container determination module 118 can compile contextual data to send to the container store 106 to determine which container to provide. The contextual data can include local sensor data from the host system 104, a number of connected or nearby devices, a type of connected or nearby devices, a time of day, a geographic (e.g., global positioning system (GPS)) location of the host system, identification of one or more users, a calendar or schedule associated with the one or more users or with the host system 104, one or more files or applications accessed, settings at the host system 104, or any data deemed relevant to selecting an appropriate container.

The contextual data can be sent to the container store 106, where the container store 106 determines a container 114 that matches the contextual data. This may comprise comparing metadata associated with one or more layers in the layer repository 116 to determine if the layers should be included in the container 114. Alternately, it may comprise determining a project that each of the users is associated with and providing a container 114 associated with the project. If multiple containers match the contextual data, the multiple containers can be ranked based on the contextual data to determine a best fit container, and the best fit container can be provided to the host system 104. Alternately, a list of the multiple containers can be presented at the host system 104 for selection by the user. In the case that a container does not match the contextual data, an error can be returned to the container transferring system 102, or the contextual data can be broadened and an additional search for a matching container can be performed. If a container is still not found, the container transferring system 102 can create a new container for the user or present an error message at the host system.

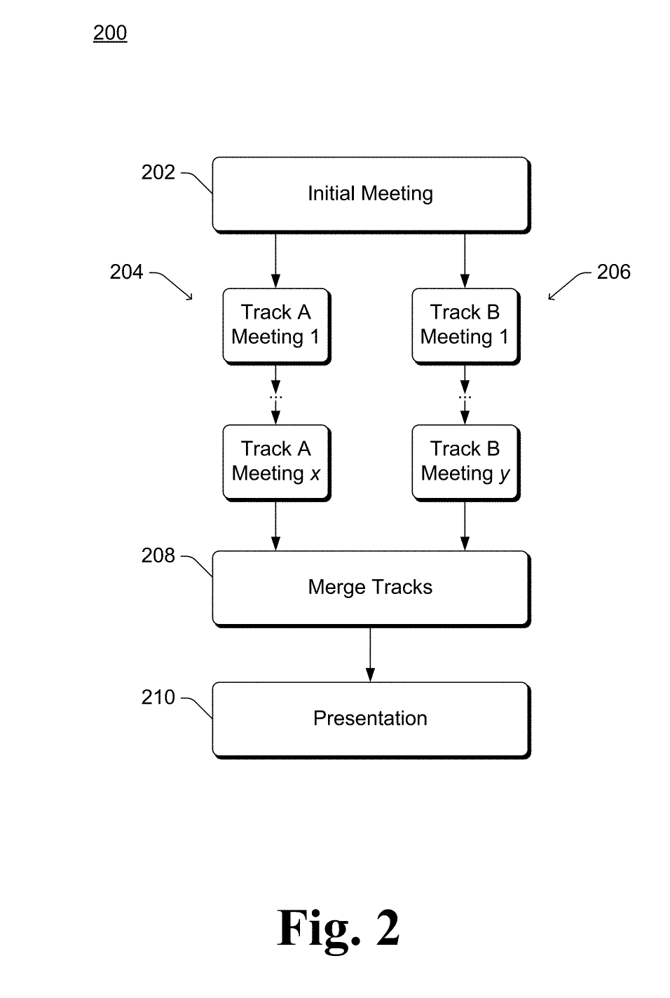

FIG. 2 is a data flow illustrating an example usage flow 200 for transferring containers in accordance with one or more embodiments. Flow 200 is simply an example data flow and can alternately comprise fewer or additional elements.

Data flow 200 illustrates an example embodiment in which two teams of users are working on a same project. The project begins with an initial meeting 202. This initial meeting 202 is associated with a container that includes one or more programs, files, or settings desired for the meeting. The container can be pre-built or built on the fly. The container can be a standard container or can be dynamically created for the meeting. The initial meeting 202 can be, for example, a project kick off meeting in which general brain storming occurs in a word document. The document can be saved into the container associated with the meeting. The document can be saved to a layer of the container that is accessible to all users associated with the project kick off meeting.

Following the initial meeting 202, the users split into two tracks, shown as track A and track B. Alternately, additional tracks could also be included. For instance, if the attendees of the initial meeting 202 included people from a design team and a marketing team, each team could be associated with a track, though it should be noted that each individual user could be associated with a track, or tracks could be broken out with any desired subset of users. In the data flow 200, track A 204 and track B 206 are each be associated with one or more layers that can be secured such that users not associated with the specific track cannot access data stored in the layers associated with the track.

For instance, the design team may be associated with track A 204 and the marketing team with track B 206. Following the initial meeting 202, the design team can have multiple (x) meetings in which brainstorming and early embodiments of an idea are not suitable for release to the public and thus should not be shared with the marketing team. This can be stored in a layer that is specific to the design team and is not accessible to the marketing team.

Meanwhile, the marketing team can be working within track B 206 and also have multiple (y) meetings. Track B 206 can be associated with one or more layers. As described above with regards to track A, the layers can be private to users associated with the marketing team. Alternately, one or more of the layers created in track B can be accessible to a wider variety of users, including one or more users associated with the design team.

Following the completion of the track A 204 and track B 206 meetings, the design team and marketing team are ready to merge the tracks 208. Each team can specify one or more layers to be included in the merged container. In this way, the teams can control the data that is available in the final container.

After the tracks have been merged, the container is ready to be presented. This can comprise, for example, adding a superset of users that were previously not associated with the meeting, such as an executive board. The presentation 210 can comprise adding users with varying degrees of access such as a “view-only” capacity rather than a read/write capacity such that changes made to the container by these users are not saved to the container.

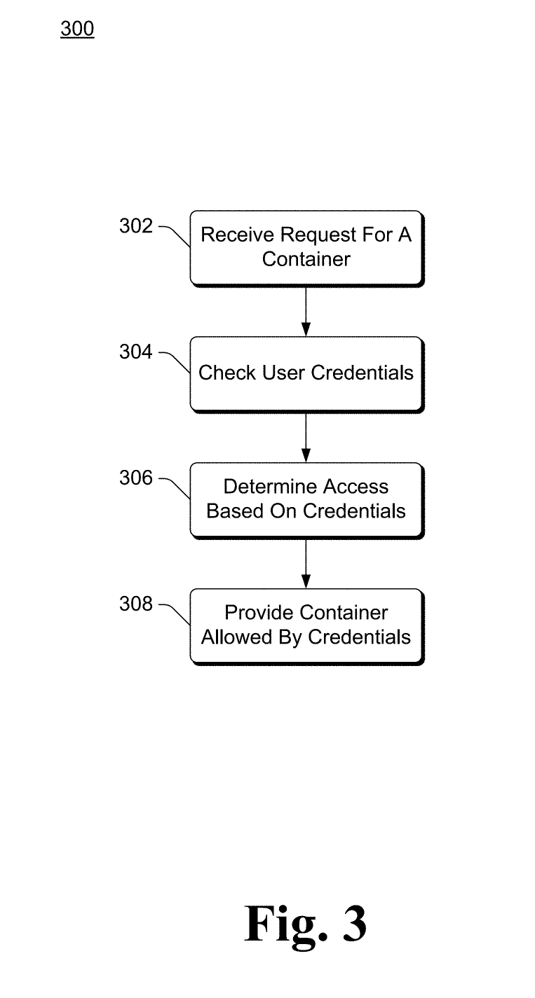

FIG. 3 is a flowchart illustrating an example process 300 for transferring containers in accordance with one or more embodiments. Process 300 is carried out by a system, such as system 100 of FIG. 1, and can be implemented in software, firmware, hardware, or combinations thereof. Process 300 is shown as a set of acts and is not limited to the order shown for performing the operations of the various acts. Process 300 is an example process for transferring containers; additional discussions of transferring containers are included herein with reference to different figures.

In process 300, a request for a container is received (act 302). This request can be received at the host system 104 from a user, received from a schedule of meetings, or in any other desired way.

The user's credentials are checked (act 304). This can take the form of the user entering a username and password, the user being recognized via biometric scanning, supplying a key card, or any other desired credentials, and so forth. Checking user credentials can further include checking the credentials of multiple users. For instance, it can be required that each person in a room present their credentials in order for a layer or container to be accessed. Alternately, a certain threshold of users must present credentials (e.g., more than one person, 20% of people in attendance, or 20% of people associated with the desired layer). This threshold can be set by users or can be standard across an enterprise, and can vary between layers within the same container.

Access to a container can be determined based on the presented credentials (act 306). This determining can be done by the authentication module of the container transferring system 102. For instance, it can be determined that a user has access to the container associated with the meeting including the base layer, as well as a team specific layer, and a layer associated with the user, but that the user does not have access to a second team layer. Access to a layer can take multiple forms including view-only access and read/write access. Determining access can be referred to as determining a level of access in which the level represents an amount of data within the container that a user has permission to access. This can include different files, applications, programs, layers, and so on, and can further include editing permission.

The container is provided as allowed by the user credentials (308). This can comprise the container transferring system 102 retrieving the container 114 from the container store 106 and one or more layers from the layer repository 116 and providing the container and layers to the host system 104.

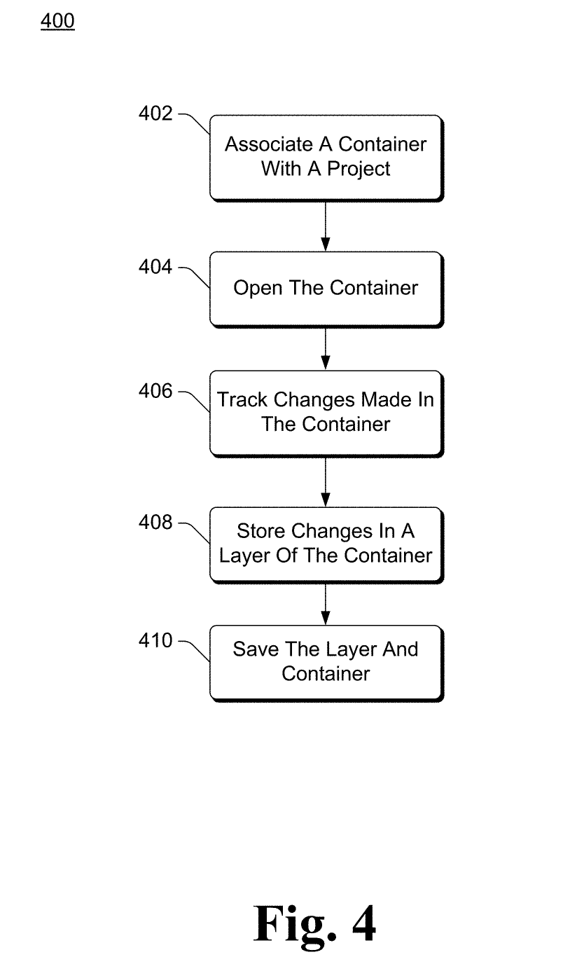

FIG. 4 is a flowchart illustrating an example process 400 for transferring containers in accordance with one or more embodiments. Process 400 is carried out by a system, such as system 100 of FIG. 1, and can be implemented in software, firmware, hardware, or combinations thereof. Process 400 is shown as a set of acts and is not limited to the order shown for performing the operations of the various acts. Process 400 is an example process for transferring containers; additional discussions of transferring containers are included herein with reference to different figures.

In process 400, a container is associated with a project (act 402). A container can be associated with a project at any point. For example, during the initial meeting 202, a container can be created and associated with a specific meeting. During the Track A 204 and Track B 206 meetings, the container associated with the project during the initial meeting 202 can be used. Alternately, individual layers can be associated with a project, and when these layers are used to create a container, the container can be associated with the project.

The container is opened (act 404). Opening the container can comprise opening a previously used container, or creating a new container. The container can be opened at a host system 104, and can optionally require that one or more users be authenticated prior to opening. The container can be opened responsive to a trigger such as a certain time being reached (e.g., a scheduled time for a meeting), a certain group of users being authenticated, a request for a container to be opened, or any other appropriate trigger.

Changes made in the container are tracked (act 406). This can include tracking changes that are made within the container to a document or file, as well as tracking changes made to the container itself, such as adding one or more applications or files, or changing one or more settings. The changes can further be associated with a user or group of users. For instance, if multiple users are accessing a container at once, the changes made by a particular user can be associated with a user identifier, or can be associated with a time or meeting identifier.

The changes are stored in a layer of the container (act 408). This layer can be any appropriate layer. For instance, if a change is made to the applications present in a container, this change can be stored in the base layer of the container and the change can be visible by any user who accesses the container. Alternately, the change can be stored in a layer associated with a team or group of users and can be visible only to users who have access to the team or group layer. Alternately, the change can be stored in a layer associated with the user, and only accessible by the user.

The layer in which the changes are stored can be a layer that was received from the layer repository 116 and was previously associated with the container. Alternately, a layer can be created specifically to store the changes.

The changes to the layer and container are saved (act 410). These changes can be saved periodically over the use of the container, or can be saved when the user is finished with the container.

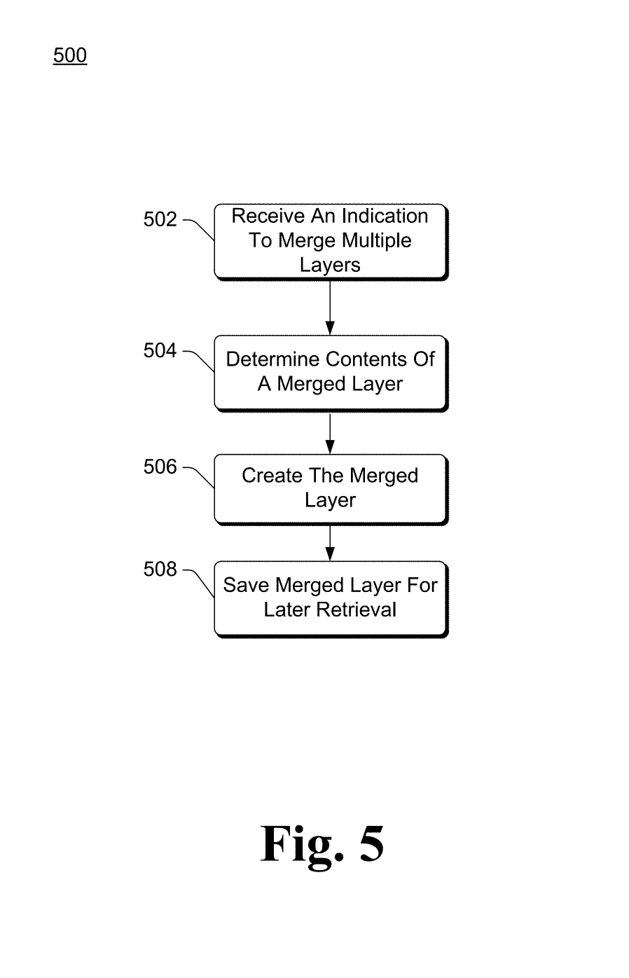

FIG. 5 is a flowchart illustrating an example process 500 for transferring containers in accordance with one or more embodiments. Process 500 is carried out by a system, such as system 100 of FIG. 1, and can be implemented in software, firmware, hardware, or combinations thereof. Process 500 is shown as a set of acts and is not limited to the order shown for performing the operations of the various acts. Process 500 is an example process for transferring containers; additional discussions of transferring containers are included herein with reference to different figures.

In process 500, an indication to merge multiple layers is received (act 502). This can take the form of a direct input requesting that multiple layers be merged, receiving credentials from users associated with one or more layers, or any other desired indication. The indication can be received, for example, by the input module 108 of the container transferring system 102.

An indication to merge multiple layers could be received when multiple tracks are merged such as at merge tracks 208 of usage flow 200 of FIG. 2. Alternately, layers can be merged when multiple users want to access their user specific layers simultaneously, for instance during a meeting occurring within track A 204.

The contents of the merged layer are determined (act 504). This can take the form of a user or group of users signing off that a layer or part of a layer should be included in the merged layer. Alternately, layers could be pre-associated with permissions such that responsive to the indication to merge multiple tracks, the layer can be automatically determined, for instance by the container management module 112.

A merged layer is created (act 506). This merged layer creation can comprise combining multiple layers into a single layer, or can comprise a layer that references multiple other layers. The merged layer can be created, for example, by the container management module 112.

The merged layer is saved (act 508). The layer can be saved to the layer repository 116 or can be saved as part of the container in the container store 106.

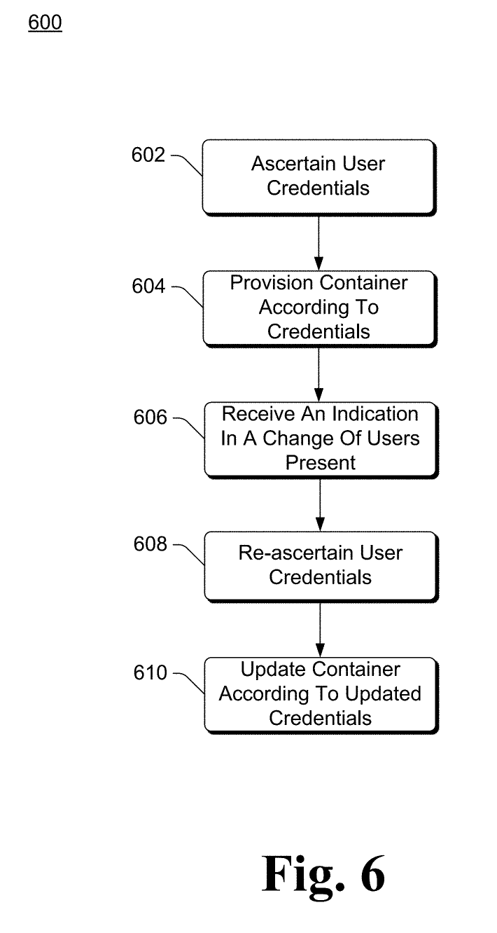

FIG. 6 is a flowchart illustrating an example process 600 for transferring containers in accordance with one or more embodiments. Process 600 is carried out by a system, such as system 100 of FIG. 1, and can be implemented in software, firmware, hardware, or combinations thereof. Process 600 is shown as a set of acts and is not limited to the order shown for performing the operations of the various acts. Process 600 is an example process for transferring containers; additional discussions of transferring containers are included herein with reference to different figures.

In process 600, user credentials are ascertained (act 602). These can be credentials of one or more users and can comprise biometric credentials, password, NFC, presence of a computing device associated with a user, and so on. The credentials can be obtained by the host system 104 and authorized by the authentication module 110.

Once the credentials have been authenticated, a container is provisioned according to the credentials (act 604). This comprises providing the container with appropriate layers including the base layer, team layer, and so on associated with the credentials. The credentials may be associated with multiple users. For instance, if a host system 104 is located in a meeting room, each person present in the room can be required to present credentials prior to the container being accessed. Alternately, the credentials of a single user can be sufficient. The container can include one or more layers that a particular user is required to be present to view. For instance, a user specific layer.

An indication of a change in the users present is received (act 606). This change can include, for example, one or more people entering or exiting a space, and can be detected by one or more sensors including motion sensors, cameras, and so on. The indication of the change can cause one or more sensitive layers to be hidden until credentials are reestablished.

The user credentials are re-ascertained (act 608). This can be done automatically by the one or more sensors, such as by recognizing a user based on one or more biometric credentials. Alternately, a message can be displayed by the host system 104 informing the user of the need for additional credentials.

The container is updated according to the updated credentials (act 610). For instance, if a new person has entered the room, their user specific layer can be retrieved and added to the container. Alternately, if a user leaves a room, one or more layers associated with the user can be hidden or closed.

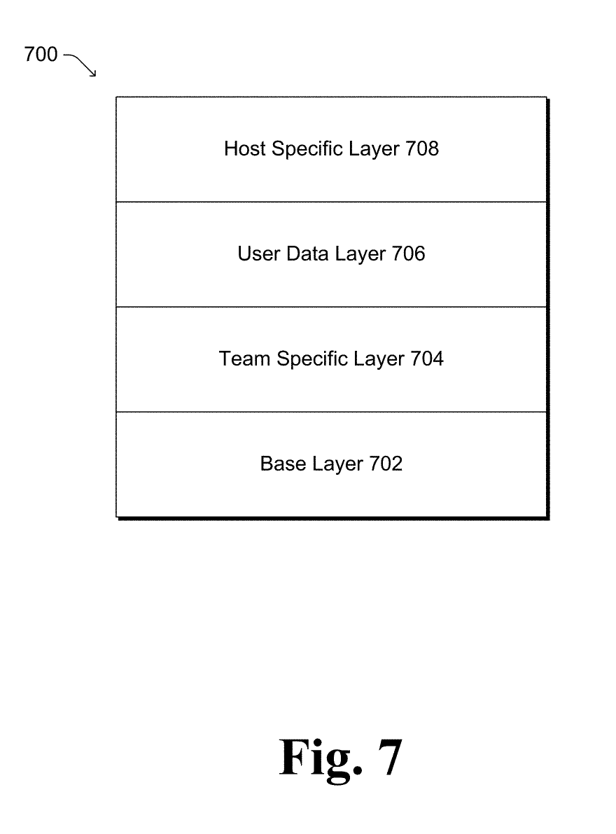

FIG. 7 is an example of a container 700 in accordance with one or more embodiments. The pictured layers are a single example of layers that can be included in a container 114 and could be combined into fewer layers, broken out into additional layers, or different layers can be included. Layers can be stored in the layer repository 116 which can be a part of the container store 106 or can be implemented separately. Layers can be used in order to maintain data in a way that is easy to access by its owner or owners while also maintaining privacy from other users.

Layers can be added or removed from a container at any time, including during the use of a container. For instance, if a container 114 is created for an original meeting, the layers can be updated to reflect changes made during the meeting. Additionally, a layer can be added or removed when a user enters or leaves a meeting.

Layers can be created or selected from a layer repository 116. A base layer can include applications and data that should be accessible to every person with access to the container. The applications can be determined based on files included in the initial meeting, based on the users or combination of users associated with the meeting, and can be updated over the course of the project. The user settings that are included in the container can be any combination of user settings from the associated users. For example, any accessibility settings required by any single user can be included in the container. The user settings can apply globally to the container or be specific to applications loaded in the container.

A base layer 702 can be a component of the container 114 accessible to any user with permission to access the container. The base layer 702 can include applications, files, and settings. The original base layer 702 can be a standard layer used for all containers within an enterprise or can be created specifically for the project.

A team specific layer 704 can be included. The team specific layer 704 can include information that is restricted to users who can be authenticated to be part of a set of users identified as a team. As described above, these teams could be a marketing team, a design team, or any other team. A team need not be made of users in a same department, but can instead be defined as any desired group of users given permission to access a team specific layer. The team specific layer 704 can include applications, files, settings, and so on that are not included in the base layer 702, or can optionally remove applications, files, settings, and so on that are included in the base layer 702. The applications, files, settings, and so on can be removed in any desired way, including the team specific layer 704 causing the CAD program to be hidden in the container 114, overriding the base layer 702 to delete the program from the container 114, causing the program to be removed from base layer 702 and optionally moved up into one or more other team specific layers, and so forth.

For instance, if a computer-aided design (CAD) program is included in the container for the initial meeting, but the marketing team does not need access to the CAD program during their track of the project, the team specific layer 704 can cause the CAD program not to be included in the container 114 provided.

A user data layer 706 can optionally be multiple layers for each user or a single layer that combines user data for the meeting. User data can be applications, application settings, accessibility settings, stored credentials, references to information locations and so on. A user data layer 706 can be stored in the layer repository 116, stored as part of a user profile, or created specifically for a container 114.

A host specific layer 708 can be applied by the container transferring system 102 or by the host system 104 and can include a theme, background image, display settings, and so on. The host system 104 can implement a learning system and store and add the host specific layer 708 upon receiving the container 114. The host specific layer can additionally include display themes, settings, applications, files, and so on associated with a specific host system 104. This can include provisions for external devices not available at all host systems 104 such as Bluetooth, speakers, headsets, and so on.

Although particular functionality is discussed herein with reference to particular modules, it should be noted that the functionality of individual modules discussed herein can be separated into multiple modules, and/or at least some functionality of multiple modules can be combined into a single module. Additionally, a particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

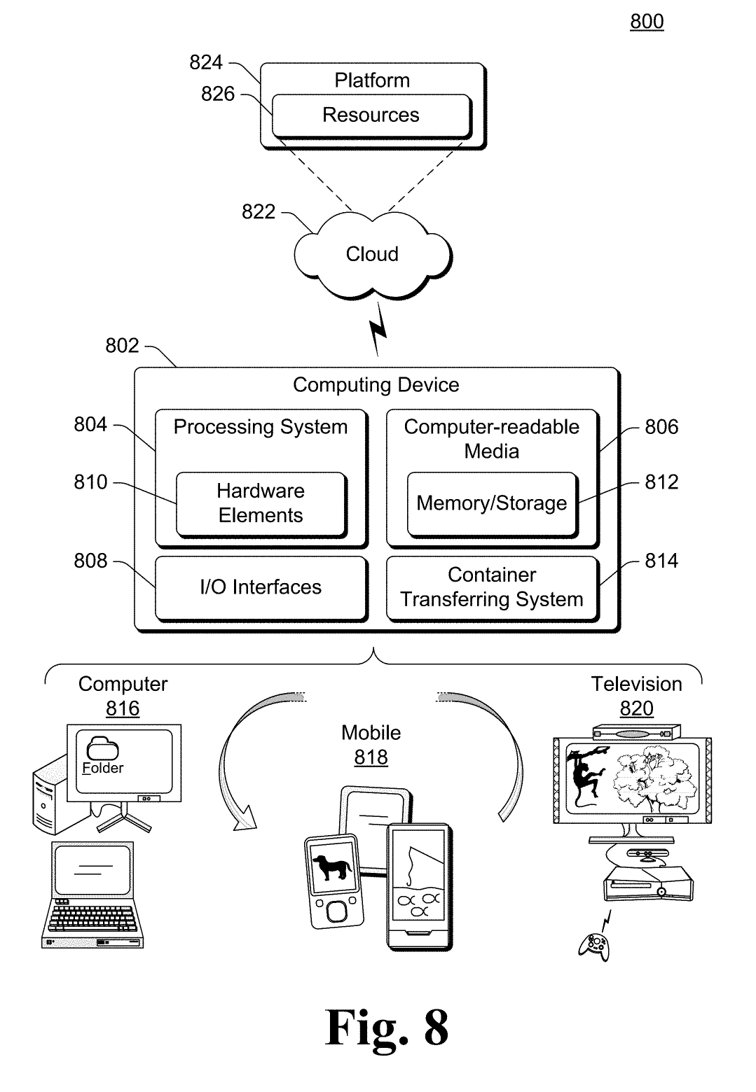

FIG. 8 illustrates an example system generally at 800 that includes an example computing device 802 that is representative of one or more systems and/or devices that may implement the various techniques described herein. The computing device 802 may be, for example, a server of a service provider, a device associated with a client (e.g., a client device), an on-chip system, and/or any other suitable computing device or computing system.

The example computing device 802 as illustrated includes a processing system 804, one or more computer-readable media 806, and one or more I/O Interfaces 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware elements 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 806 is illustrated as including memory/storage 812. The memory/storage 812 represents memory/storage capacity associated with one or more computer-readable media. The memory/storage 812 may include volatile media (such as random access memory (RAM)) and/or nonvolatile media (such as read only memory (ROM), Flash memory, optical disks, magnetic disks, and so forth). The memory/storage 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

The one or more input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 802 may be configured in a variety of ways as further described below to support user interaction.

The computing device 802 also includes a container transferring system 814. The container transferring system 814 provides various functionality supporting transferring containers as discussed herein. The container transferring system 814 can implement, for example, the host system 104, container transferring system 102, container store 106, and/ or layer repository 116 of FIG. 1.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” refers to media and/or devices that enable persistent storage of information and/or storage that is tangible, in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, the hardware elements 810 and computer-readable media 806 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of modules as a module that is executable by the computing device 802 as software may be achieved at least partially in hardware, e.g., through use of computer-readable storage media and/or hardware elements 810 of the processing system. The instructions and/or functions may be executable/operable by one or more articles of manufacture (for example, one or more computing devices 802 and/or processing systems 804) to implement techniques, modules, and examples described herein.

As further illustrated in FIG. 6, the example system 800 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 800, multiple devices are interconnected through a central computing device. The central computing device may be local to the multiple devices or may be located remotely from the multiple devices. In one or more embodiments, the central computing device may be a cloud of one or more server computers that are connected to the multiple devices through a network, the Internet, or other data communication link.

In one or more embodiments, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one or more embodiments, a class of target devices is created and experiences are tailored to the generic class of devices. A class of devices may be defined by physical features, types of usage, or other common characteristics of the devices.

In various implementations, the computing device 802 may assume a variety of different configurations, such as for computer 816, mobile 818, and television 820 uses. Each of these configurations includes devices that may have generally different constructs and capabilities, and thus the computing device 802 may be configured according to one or more of the different device classes. For instance, the computing device 802 may be implemented as the computer 816 class of a device that includes a personal computer, desktop computer, a multi-screen computer, laptop computer, netbook, and so on.

The computing device 802 may also be implemented as the mobile 818 class of device that includes mobile devices, such as a mobile phone, portable music player, portable gaming device, a tablet computer, a multi-screen computer, and so on. The computing device 802 may also be implemented as the television 820 class of device that includes devices having or connected to generally larger screens in casual viewing environments. These devices include televisions, set-top boxes, gaming consoles, and so on.

The techniques described herein may be supported by these various configurations of the computing device 802 and are not limited to the specific examples of the techniques described herein. This functionality may also be implemented all or in part through use of a distributed system, such as over a “cloud” 822 via a platform 824 as described below.

The cloud 822 includes and/or is representative of a platform 824 for resources 826. The platform 824 abstracts underlying functionality of hardware (e.g., servers) and software resources of the cloud 822. The resources 826 may include applications and/or data that can be utilized while computer processing is executed on servers that are remote from the computing device 802. Resources 826 can also include services provided over the Internet and/or through a subscriber network, such as a cellular or Wi-Fi network.

The platform 824 may abstract resources and functions to connect the computing device 802 with other computing devices. The platform 824 may also serve to abstract scaling of resources to provide a corresponding level of scale to encountered demand for the resources 826 that are implemented via the platform 824. Accordingly, in an interconnected device embodiment, implementation of functionality described herein may be distributed throughout the system 800. For example, the functionality may be implemented in part on the computing device 802 as well as via the platform 824 that abstracts the functionality of the cloud 822.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments.

A method comprising: associating a container with a project, the container comprising an isolated computing space and containing one or more programs or files; opening the container at a host device responsive to one or more triggers indicating a usage session is starting; recording one or more changes made during the usage session to one or more application, layer, or data contained in the container; and saving the container and the one or more changes.

Alternatively or in addition to any of the above described methods, any one or combination of: the method further comprising reopening the container and recording one or more additional changes; the container comprising multiple layers, each layer of the multiple layers comprising one or more application, setting, data access point, or file; at least one of the multiple layers requiring authentication for access; at least one of the multiple layers requiring a threshold of users to be present for access; at least one of the multiple layers removing one or more application, setting, data access point, or file contained in a different of the multiple layers; the one or more changes comprising adding or removing one or more applications; the method further comprising reopening the container, and adding one or more layers to the container; the method further comprising associating the project and container with one or more emails or chat sessions that occur outside the container; the one or more changes associated with a specific user; the container comprising one or more references to locations where data is stored; the container further comprising one or more authentication credentials to access the data from the stored location.

A computer-implemented method for project containers, the method comprising: authenticating one or more users of a container at a host system; retrieving the container from a container store for use at the host system, the container providing an isolated computing session at the host system and containing one or more program or link to data; tracking one or more changes made to the container, the one or more changes associated with the one or more users; and saving the container and the one or more changes.

Alternatively or in addition to any of the above described methods, any one or combination of: the one or more changes saved in a layer of the container; the tracking the one or more changes comprising tracking a set of changes made by each of the one or more users and saving the set of changes for each user to a layer of the container associated with the user; the authenticating the one or more users causing the container to provide access to one or more layers of the container and deny access to one or more other layers of the container.

A computing device comprising: a processor; and a computer-readable storage media having stored thereon multiple instructions that, when executed by the processor, cause the processor to: receive a request for a container associated with a project, the container providing an isolated computing space for the project at one or more computing devices; authenticate a user to determine whether to give access to all, part, or none of the container; provide the container at the determined level of access; receive one or more inputs that cause a change to the container; and save the change to the container.

Alternatively or in addition to any of the above described computing devices, any one or combination of: the determined level of access comprising one or more layers to which the user is granted access and one or more layers to which the user is denied access; the change to the container saved in a layer of the container associated with the user; the change to the container comprising adding or removing one or more applications.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
associating a container with a project, the container comprising an isolated computing space and containing one or more programs or files;
opening the container at a host device responsive to one or more triggers indicating a usage session is starting;
recording one or more changes made during the usage session to one or more application, layer, or data contained in the container; and
saving the container and the one or more changes.

2. A method as recited in claim 1, the method further comprising reopening the container and recording one or more additional changes.

3. A method as recited in claim 1, the container comprising multiple layers, each layer of the multiple layers comprising one or more application, setting, data access point, or file.

4. A method as recited in claim 3, at least one of the multiple layers requiring authentication for access.

5. A method as recited in claim 3, at least one of the multiple layers requiring a threshold of users to be present for access.

6. A method as recited in claim 3, at least one of the multiple layers removing one or more application, setting, data access point, or file contained in a different of the multiple layers.

7. A method as recited in claim 1, the one or more changes comprising adding or removing one or more applications.

8. A method as recited in claim 1, further comprising reopening the container, and adding one or more layers to the container.

9. A method as recited in claim 1, further comprising associating the project and container with one or more emails or chat sessions that occur outside the container.

10. A method as recited in claim 1, the one or more changes associated with a specific user.

11. A method as recited in claim 1, the container comprising one or more references to locations where data is stored.

12. A method as recited in claim 11, the container further comprising one or more authentication credentials to access the data from the stored location.

13. A computer-implemented method for project containers, the method comprising:
authenticating one or more users of a container at a host system;
retrieving the container from a container store for use at the host system, the container providing an isolated computing session at the host system and containing one or more program or link to data;
tracking one or more changes made to the container, the one or more changes associated with the one or more users; and
saving the container and the one or more changes.

14. A computer-implemented method as recited in claim 13, the one or more changes saved in a layer of the container.

15. A computer-implemented method as recited in claim 13, the tracking the one or more changes comprising tracking a set of changes made by each of the one or more users and saving the set of changes for each user to a layer of the container associated with the user.

16. A computer-implemented method as recited in claim 13, the authenticating the one or more users causing the container to provide access to one or more layers of the container and deny access to one or more other layers of the container.

17. A computing device comprising:
a processor; and
a computer-readable storage media having stored thereon multiple instructions that, when executed by the processor, cause the processor to:
receive a request for a container associated with a project, the container providing an isolated computing space for the project at one or more computing devices;
authenticate a user to determine whether to give access to all, part, or none of the container;
provide the container at the determined level of access;
receive one or more inputs that cause a change to the container; and
save the change to the container.

18. A computing device as recited in claim 17, the determined level of access comprising one or more layers to which the user is granted access and one or more layers to which the user is denied access.

19. A computing device as recited in claim 17, the change to the container saved in a layer of the container associated with the user.

20. A computing device as recited in claim 17, the change to the container comprising adding or removing one or more applications.
